(19) United States
(12) Patent Application Publication
(10) Pub. No.: US 2024/0183981 A1
(43) Pub. Date: Jun. 6, 2024

(54) Optoelectronic sensor and method for the detection and distance determination of objects

(71) Applicant: SICK, Waldkirch (DE)

(72) Inventors: Patrick STEIN, Waldkirch (DE); Christiane FILLHARDT, Waldkirch (DE); Markus HAMMES, Waldkirch (DE); Joachim KRÄMER, Waldkirch (DE); Michael BREINDL, Waldkirch (DE)

(21) Appl. No.: 18/526,126

(22) Filed: Dec. 1, 2023

(30) Foreign Application Priority Data
Dec. 6, 2022 (DE) 102022132310.2

(51) Int. Cl. G01S 17/04; G01S 7/481; G01S 7/4861; G01S 7/4865; G01S 17/931

(52) U.S. Cl. CPC G01S 17/04; G01S 7/4817; G01S 7/4861; G01S 7/4865; G01S 17/931

(57) ABSTRACT

An optoelectronic sensor for the detection and distance determination of objects in a monitored zone has a light transmitter for transmitting a transmitted pulse, a deflection unit for transmitting the transmitted pulses in different angular positions, a light receiver for generating a received signal, and a control and evaluation unit configured to recognize a received pulse that the transmitted pulse remitted or reflected in the monitored zone generates in the received signal, and to measure a distance between the transmission of the transmitted pulse and the reception of the received pulse with reference to a time of flight, as well as to recognize the presence of fog by evaluating the received signal. The control and evaluation unit is furthermore configured to recognize the presence of fog by checking a time portion of the received signal with a fog signature corresponding to the received pulse.

The invention relates to an optoelectronic sensor and to a method for the detection and distance determination of objects in a monitored zone in accordance with the preambles of claim 1 and claim 15 respectively.

A distance measuring optoelectronic sensor transmits a light beam into the monitored zone and the light beam reflected back by objects is received again to electronically evaluate the received signal. The distance of a scanned object is determined from the time of flight of the light beam transmitted and received again. This measurement principle is used for a planar scanning in a laser scanner. The light beam periodically sweeps over the monitored zone with the aid of a deflection unit. The respectively measured distance is associated with an angular location of the deflection unit and the site of an object in the monitored zone is thus detected in two-dimensional polar coordinates. The third spatial coordinate can be covered by a relative movement in the transverse direction.

Laser scanners are used in safety technology for monitoring a hazard source, such as a hazardous machine. Such a safety laser scanner is known from DE 43 40 756 A1. In this process, a protected field is monitored which may not be entered by operators during the operation of the machine. If the laser scanner recognizes an unauthorized intrusion into the protected field, for instance a leg of an operator, it triggers an emergency stop of the machine. Sensors used in safety technology have to work particularly reliably and must therefore satisfy high safety demands, for example the EN13849 standard for safety of machinery and the machinery standard EN1496 for electrosensitive protective equipment (ESPE). A number of measures have to be taken to satisfy these safety standards such as reliable electronic evaluation by redundant, diverse electronics, function monitoring or specifically monitoring the soiling of optical components, in particular of a front screen, and/or provision of individual test targets with defined degrees of reflection which have to be recognized at the corresponding scanning angles.

On a use in the outdoor area, the environmental influences, in particular fog, rain and snow, represent special challenges for reliability and smooth operation. While these weather influences can be excluded in the indoor area in accordance with the intended purpose, they are necessarily present and not controllable in the outdoor area, but are very relevant to the productive routine in the logistics or production environment. A complete freedom from interaction between the optoelectronic sensor and the weather influences is as a rule not possible with a reasonable effort.

Fog is particularly disadvantageous in technical safety applications since there are effects both on availability and safety. The availability is impaired because the fog echo is strong enough during dense fog to treat the fog as an object relevant to safety. A monitored machine therefore has to be set into a safe state even though there is objectively no hazard situation at all. Fog can even become safety critical in a medium visibility range, wherein the fog is not recognized as an object, but results in a potential detection loss due to the fog damping. In this case, a hazard situation can be overlooked and this has to preclude a safe sensor in the sensor of the aforenamed standards. The countermeasure up to now comprises reducing the safe range of the sensor and thus providing an energy reserve. However, this has the consequence that the sensor also works at a reduced range at times without fog.

There is therefore a need for a safe fog recognition for an optoelectronic sensor. Safe here, as everywhere in this description, means that relevant safety standards for machine safety, personal protection, or electrosensitive protective equipment are observed.

The SICK corporation offers a “Dynamic Weather Assist” that uses sensitive warning fields to recognize adverse weather conditions and then to switch over to more robust protected fields that allow at least a slowed further operation and thus increase productivity overall. Safe fog recognition does not take place here.

The white paper of Thorsten Theilig “HDDM+—Innovative Technology from SICK for distance measurement” presents an optical distance measurement technique in which a plurality of laser pulses are statistically evaluated. There is the possibility due to its multi-echo ability to only evaluate the last echo in each case and to ignore preceding smaller echoes that are caused by fog. However, this is not safe fog recognition.

In DE 10 2009 057 104 A1, a laser distinguishes whether an object or only a disrupter has been scanned as a so-called soft target based on the shape of the received pulses. This recognition is not safe. Nor can it be recognized whether the laser scanner is still detection capable, that is, for example, whether there are further relevant targets hidden in the fog.

In EP 2 541 273 B1, the received signal is split at a splitter element into two paths for a high frequency and a low frequency portion. Hard targets or objects are detected by means of the high frequency portion while the low frequency portion is used to determine impaired visibility. This requires a double evaluation path that already begins in the analog portion of the evaluation. The evaluation in the low frequency portion does not provide any safe fog recognition.

EP 3 059 608 B1 describes a laser scanner that measures the reception level via the current in the voltage supply of the light receiver and then corrects the measured distance or adapts the evaluation algorithm. Whether a reflector was scanned can here be recognized by a comparison of the received level with a threshold. There is no correlation with fog recognition.

In EP 3 287 809 A1, a laser scanner monitors a plurality of monitored fields within a protected field and counts how often objects have been detected therein. A measure of detection safety is derived from this frequency of occurrence and at low detection safety, the further monitoring takes place more accurately and therefore with an increased response time that is in turn compensated by reduced working and movement speeds of a monitored machine or vehicle. However, the number of detected objects in particular does not increase at all with moderate fog; objects are rather actually overlooked due to the damping.

EP 3 435 117 A1 determines whether and to what distance the laser scanner described there is still capable of detection using a distribution of a plurality of distance measurements. The statistical procedure is comparatively sluggish, particularly when statements on fog influences in specific directions are looked for.

A further laser scanner is known from EP 3 588 139 A1 that measures object distances twice at different sensitivities. If differences result, a conclusion is drawn on a restriction of visibility. This only works while an object is present in the scanning beam and is scanned. The safety critical case of an overlooked object in fog with medium impaired visibility is thus actually not covered.

Against this background, it is the object of the invention to further improve the fog recognition of a sensor of the category.

This object is satisfied by an optoelectronic sensor and by a method for the detection and distance determination of objects in a monitored zone in accordance with claim 1 or claim 15 respectively. At least one transmitted pulse is transmitted into the monitored zone by a light transmitter to measure a distance with reference to a time of flight process. A light receiver generates a received signal from light of the monitored zone that has a received pule when the transmitted pulse is reflected or remitted in the monitored zone. A movable, in particular rotatable, deflection unit is provided here with whose aid the transmitted pulse is transmitted into one of a plurality of angular positions. At least one portion of a scan plane or monitored plane is thus preferably periodically scanned. The deflection unit can, for example, be formed as a rotating mirror, as a rotating optical head having a light transmitter and a light receiver, or as a solid state unit, for example based on MEMS (microelectromechanical systems) mirrors, or an OPA (optical phased array).

A control and evaluation unit evaluates the received signal to determine the time of flight between the transmission of the transmitted pulse and the reception of the received pulse and thus to determine a distance. It furthermore recognizes the presence of fog from the received signal in a manner still to be described. The sensor thus becomes deployable in the outdoor area. The recognition is directed to fog, but also reacts, as required, to other environmental influences such as rain or snow, in particular having fine droplets and thereby fog-like properties. This has comparable effects on the detection and is therefore as a rule a desired effect that will, however, no longer be separately discussed.

The invention starts from the basic idea of recognizing the presence of fog by checking the received signal with a fog signature. The fog signature corresponds to prior knowledge of properties of the received pulse in the case of fog and thus relates to the time portion of the received signal in which the received pulse is located. The fact that there is such a time portion at all already represents an implicit condition, a distance value thus namely becomes measurable. However, this time portion with fog is distinguishably different from without fog. The result is a different time distribution, a different flank behavior, and in particular increase behavior, and/or a different amplitude of the received signal than in the case of a received pulse from an object. These differences are combined in the fog signature. In the following, received pulses generated by fog are also called semi hits, in contrast with direct hits on an object. A semi hit does not yet automatically mean fog since there are, for example, edge hits where the transmitted light spot is incident on two objects at different distances and that are likewise not direct hits. In addition semi hits are strictly speaking produced by fog of medium visibility. Dense fog can by all means generate direct hits; very weak fog like other disruptive and noise effects will possibly not be registered at all. The interesting scenario is fog of medium visibility since a sensible function is anyway no longer ensured with dense fog and weak fog can be ignored.

The invention has the advantage that larger ranges are made possible since an energy reserve for fog no longer has to be provided. A response to the fog is thus only situative and not prophylactic. Dense fog is extremely rare in most outdoor applications and now no longer has to be taken into account in all energy observations. The availability is considerably increased. Dense fog is directly recognized as such; a monitored machine can then, for example, continue to work at a reduced speed instead of, as conventionally, switching the machine to its safe state, to switch it off as a rule and to wait for better visual conditions. Detection losses under specific fog conditions are no longer possible since in these cases the fog recognition is triggered. For example, a switch to more robust protected field configurations can be made as a response or a work speed can be reduced, in particular the speed of a monitored vehicle.

The control and evaluation unit is preferably configured to recognize the presence of fog when the check with the fog signature produces this for a plurality of angular positions. It is by all means imaginable for a smaller object that it is only detected at a single angular position. Fog is, however, typically extensive. It must therefore be expected with fog that the criteria for fog specified by the fog signature are present at a plurality of angular positions. In simple terms, in the nomenclature of semi hits and direct hits, there are many semi hits and not just isolated semi hits. A check is thus made with the fog signature whether there is a typical accumulation for fog, in particular a minimum number of semi hits.

The control and evaluation unit is preferably configured to recognize the presence of fog when the check with the fog signature produces this for at least m of n angular positions disposed next to one another. In this embodiment, it is more specifically required that fog is recognized at adjacent angular positions. The accumulation of semi hits is now not distributed somewhere over the monitored zone, but rather specifically required in a cluster. A minimum number of angular positions with recognized fog could otherwise falsely result from a plurality of isolated angular positions in which the fog signature has not distinguished between fog and other received signals with sufficient distinction. In this respect, the rule is in turn too strict in practice of recognizing the fog in a neighboring region for all the angular positions. This is therefore weakened to the demand of m from n, where m<n are natural numbers, for example in the range up to twenty such as m=4 . . . 7 from n=8 . . . 12. The measured result can be as desired at the remaining n-m angular positions; for example, a direct hit on one object or no distance at all can be measured there.

The sensor preferably has a filter that is arranged downstream of the light receiver and that converts a received pulse into an oscillation, with the fog signature having a reduced amplitude of at least one first oscillation, a changed sign of the at least one first oscillation, and/or a changed number of oscillations. Such a filter can be a bandpass filter, for example. In illustrative terms, the received pulse starts a oscillation in the filter by which the energy of the received pulse is distributed over the oscillation. The fog signature can now apply criteria to the oscillations that provides considerably more characteristics than a simple received pulse. Fog changes the course of the signal in a striking manner with respect to properties such as a slow oscillation start, inversions, and phase transitions. This can be checked via sequences, distances, and signs of local extremes. An extreme here means that an observed single oscillation within the course of the signal exceeds or falls below an amplitude threshold of the fog signature. The fog signature can in particular be displayed in that the first oscillation, that is the first extreme of the oscillation, is considerably less pronounced than with an object, that is only approximately half as strong. It has further been shown that with fog the first oscillation frequently oscillates in a different direction than with an object so that the fog signature can include the changed sign. The effects of the fog do not necessarily only extend to the first oscillation, it may be sensible to observe the second oscillation, third oscillation, and further oscillations, with the differences no longer being so easily recognizable at the latest after the third oscillation. Finally, there can be a changed number of oscillations until the oscillation has decayed in full and this can also be part of the fog signature.

The control and evaluation unit is preferably configured to transmit a plurality of individual light pulses per angular position that respectively scan light pulses received again with only a few thresholds, in particular to binarize them with a single threshold and to accumulate the scans to form a digital received signal. In this embodiment, work is carried out using a pulse averaging process that statistically evaluates a plurality of individual measurements with per se too little energy for a robust signal-to-noise ratio. The received signal is respectively not digitized with a greater bit depth for a very simple hardware implementation, but is only scanned with one threshold or with very few thresholds. A received signal that can be evaluated is only produced by the accumulation of a plurality of individual signals of the individual measurements. Due to the deflection unit, the individual light pulses of a measurement are strictly speaking not transmitted in the same angular position, but into a narrow angular sector with which an angular position can be associated.

The control and evaluation unit is preferably configured to recognize the presence of fog only when at least one additional criterion is satisfied in addition to the check with the fog signature, namely that measured values outside a minimum distance disappear, that a measured distance is in a fog distance region, that the received signal has an intensity expected for fog, and/or that no reflector has been recognized. The recognition of fog based on the fog signature is considered insufficiently reliable in this embodiment and at least one additional criterion is therefore added. In this respect, a plurality of additional criteria are specifically named of which a plurality are preferably applied in the different conceivable combinations or that are preferably all applied together. A weighting is conceivable with combinations of a plurality of additional criteria. The first additional criterion relates to the failure of measured values to be expected with fog at distances that are too great. The fog here suppresses the signal levels so that more distant objects are no longer detected. The second additional criterion requires that a measurement with a satisfied fog signature produces a distance in a fog distance region. In other words, in accordance with the second additional criterion, a semi hit should be at a minimum distance and/or at a maximum distance. The third additional criterion relates to the intensity or to the level that namely corresponds to an expected intensity in the presence of fog. In accordance with the fourth additional criterion, no reflector may be recognized by the observed measurement.

The control and evaluation unit is preferably configured for safe fog recognition in the sense of a safety standard for personal protection or electrosensitive protective equipment, in particular by checking a plurality of or all the additional criteria. The fog signature, in particular with additional criteria, makes safe fog recognition possible for the first time in the sense of relevant safety standards. In technical safety applications, it is not sufficient to distinguish fog and an object from one another at a rate that is reasonably high and has possibly not yet been reached. Every single case in which a person in a protected field is incorrectly classified as fog, can result in substantial personal injury and therefore has to be avoided at all costs. The corresponding demands on failsafeness are worded in the safety standards and safe fog recognition in accordance with this embodiment satisfies these demands by a plurality of mutually diversely complementing and safeguarding fog criteria.

The control and evaluation unit is preferably configured to check, as the first additional criterion, for the presence of fog whether an expected distance measurement number of measured values outside the minimum distance has been detected, in particular over a respective predetermined time interval. In operation without fog, measured values from a greater distance are detected over and over again, by all means also outside the specified or safe range of the sensor. The signal levels from such distances with fog are no longer sufficient for a distance measurement. This absence of large measured distances is therefore a further indication of fog. The distance measurement number that indicates the expectation of the number of such large measured distances can be parameterized or it is automatically derived by statistical evaluation of distance measurements during operation without fog. Since a brief absence of large distances can be simply due to the current scenery, the first additional criterion is preferably checked over a certain time interval that in particular comprises a plurality of scans.

The fog distance region preferably comprises distances up to a maximum of 10 m, in particular between 0.5 m and 6 m. The minimum distance does not relate to the fog, but should rather distinguish signals in the extreme near zone such as are caused by a front screen, for example, from fog. If such mix-ups are precluded by additional exceptions, the lower limit can also be closer to or be exactly at zero. The fog distance region is quantified more exactly for the second additional criterion by said zone. Sufficiently dense fog that triggers a distance measurement and could therefore initially be confused with objects is typically associated with visual ranges below ten meters. This is also connected to the optical properties of the sensor that has different sensitivity depending on the distance. The distance dependent sensitivity is also called signal dynamism and a further restricted preferred fog distance region of 0.5 m . . . 1 m to 5 . . . 10 m, preferably 0.5 m to 6 m results from this signal dynamism.

The intensity preferably corresponds to an intensity expected for fog, with the expected intensity being derived from the reflectivity of a black test object, in particular that intensity that an object having a reflectivity between 10% and 200% of the reflectivity of a black test object produces. The integral under the received pulse or in embodiments having a corresponding filter under the rectified oscillation can be used as a measure for the intensity, for example. A specific reflectivity of the fog is expected with this third additional criterion. The quantification by which this specific reflectivity is put into a relationship with those of objects is preferably based on the relevant safety standards such as IEC61496-3. According to this, a worst case scenario must be taken into account in which a black test objects having 1.8% remission is still safely detected. In the upper portion of the above-named range of 10%-200%, for example from 100% onward, fog would reflect at least as much light as the black test object. This would consequently as a rule even be evaluated as a direct hit. A smaller value of, for example 10%-80% or 10%-50% is therefore even more advantageous since this is an even greater indication of fog. Too small a value below 10%, possibly also at a higher limit such as 20% or 30%, indicates fog with only very small effects that does not necessarily have to be taken into account if semi hits are produced thereby at all. Ranges such as [20% . . . 30%, 50% . . . 80%] are therefore also conceivable.

The control and evaluation unit is preferably configured for a consistency check in which fewer or no distances outside a fog distance may be measured on the presence of an intensity expected for fog. The consistency check is derived from the fog specific reflectivity. For which portion of the light would have to be present for the detection for an object having a given distance and from when the damping is so great due to the fog that a distance can no longer be measured can be derived from this. The assumption of fog having a specific fog specific reflectivity therefore corresponds to a fog distance from which a detection of objects is no longer possible. The consistency check consequently determines whether remote objects are detected that contradict the assumption, that is whether distances or even too many distances have been measured that could no longer be measured at all with the assumed fog and therefore contradict the assumption that fog of the measured fog specific reflectivity is actually present.

The control and evaluation unit is preferably configured to recognize a reflector by the fact that a current in the light receiver exceeds a reflector threshold, in particular by measuring the current in a voltage supply of the light receiver. The fourth additional criterion is thus advantageously further developed. In general, a reflector in a received pulse can be recognized due to a particularly high intensity above a reflector threshold. It is particularly preferably not the actual received signal that is evaluated for this purpose, but rather a different source is used, namely the current in the voltage supply of the light receiver. This is explained in more detail in already named EP 3 059 608 B1 which is additionally referred to. The reflector threshold can have a distance dependence; a measured distance value is present when the criteria of the fog signature are satisfied in a measurement, i.e. with a semi hit.

The control and evaluation unit is preferably configured only to recognize fog and/or no longer to recognize fog when it is confirmed over a plurality of measurements. The fog recognition in this manner contains inertia or a bandpass filter or hysteresis. The generation and disappearance of fog is a comparatively slow process and this is taken into account by the confirmation of fog recognition over a plurality of measurements. As already on a check using the fog signature over a neighborhood of angular positions, an m-of-n criterion is also conceivable here, naturally with its own m and n, that is, for example, m=100 fog have to be recognized of n=200 periodic scans by the deflection unit (frames, scans) before it is considered as fog recognition. A time observation occurs here with respect to the already discussed spatial observation in which a check is made whether there is in particular an accumulation of semi hits in a restricted neighborhood. A slowly changing accumulation over a series of a plurality of scans, that is typical for fog, is thus taken into account.

The sensor is preferably configured as a safe sensor, in particular as a safety laser scanner, that has a safe output (OSSD, output signal switching deice) and whose control and evaluation unit is configured to output a safety relevant signal over the safe output on recognition of a safety relevant event in the monitored zone. in this case, not only the fog recognition is safe in the sense of relevant safety standards, but also the whole sensor. The safety directed signal can trigger an emergency stop; it generally switches a monitored machine into a safe state. Particularly in mobile applications, a slowing down is possibly sufficient or an evasion can be the more suitable measure.

The control and evaluation unit is preferably configured to recognize a safety related event by monitoring protected fields configured in the monitored zone and to apply stricter criteria for the presence of fog at angular positions and/or distances of a protected field. The recognition of a safety related event takes place here as disseminated by protected fields that are specified by configuration within the monitored zone. A different, in particular stricter, criterion is preferably applied to the recognition of fog at positions within a protected field than outside protected fields. For example, in n adjacent angular positions here, m fog recognitions with respect to the fog signature are required and m is larger within protected fields than outside protected fields. It is another possibility that more of the above discussed additional criteria are required within protected fields or the additional criteria are made even stricter per se.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

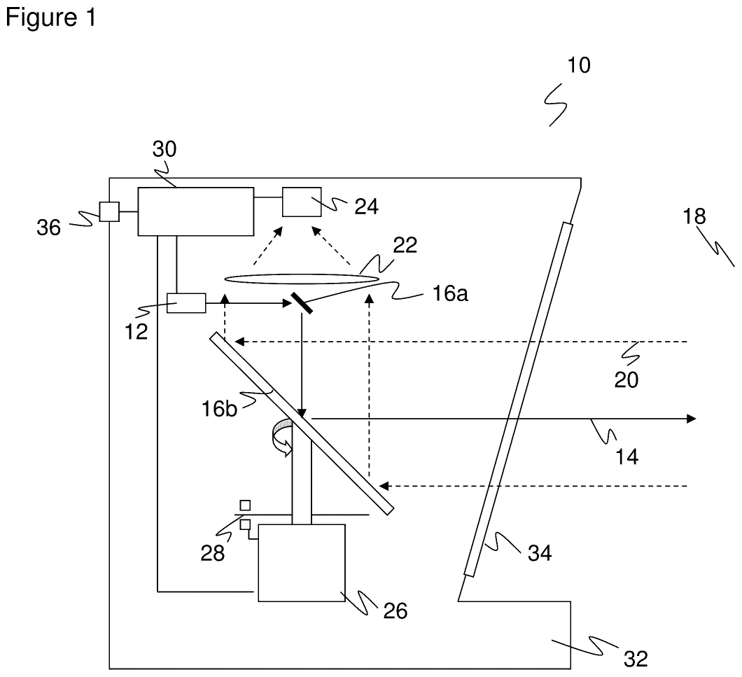

FIG. 1 a schematic sectional representation of an exemplary embodiment of a sensor in accordance with the invention with fog recognition as a laser scanner;

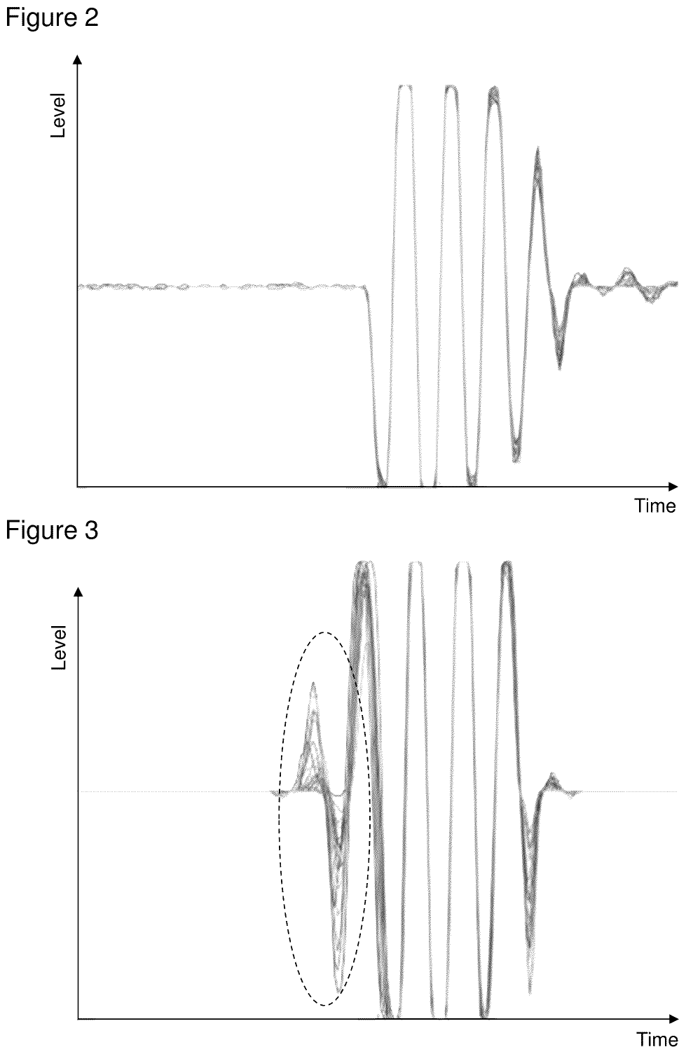

FIG. 2 an exemplary received signal of a laser scanner with a scanned object under good visibility conditions;

FIG. 3 an exemplary received signal of a laser scanner with fog; and

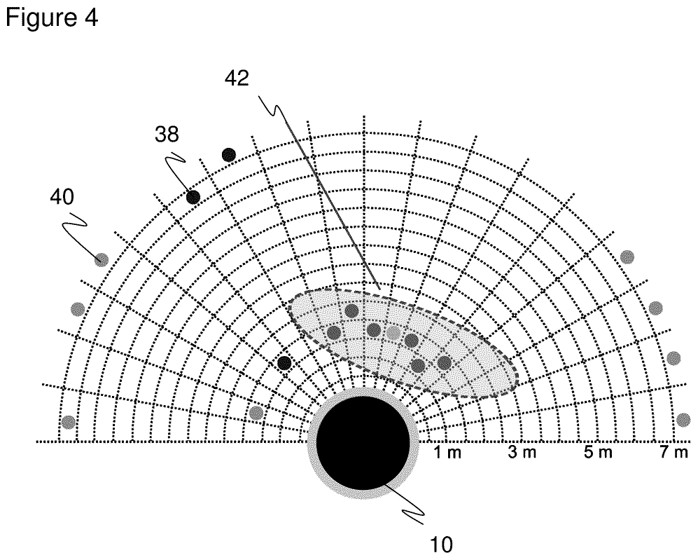

FIG. 4 a representation of measured points of a laser scanner that may be direct hits of objects or semi hits at fog for a further explanation of fog recognition.

FIG. 1 shows a schematic sectional representation through a laser scanner 10.

A light transmitter 12, for example a laser, generates a light beam 14 that preferably has one or more light pulses for a pulsed or pulse averaging process. The light beam 14 is deflected via light deflection units 16a-b into a monitored zone 18 and is remitted there by an object that may be present. The remitted light 20 again arrives back at the laser scanner 10 and is detected there by a light receiver 24, for example a photodiode or ADP (avalanche photodiode), via the deflection unit 16b and by means of an optical receiving system 22 and is converted into an electrical received signal.

The light deflection unit 16b is configured as a rotating mirror here which rotates continuously by the drive of a motor 26. The respective angular position of the light deflection unit 16b is detected via an encoder 28. The light beam 14 generated by the light transmitter 12 thus sweeps over the monitored zone 18 generated by the rotational movement. A conclusion is drawn on the angular location of the scanned object in the monitored zone 18 from the respective angular position of the deflection unit.

In addition, the time of flight of light between the transmission of the light beam 14 and the reception of the remitted light 20 after reflection at the object in the monitored zone 18 is determined and therefrom a conclusion is drawn on the distance of the object from the laser scanner 10 using the speed of light. This evaluation takes place in a control and evaluation unit 30 which is connected for this purpose to the light transmitter 12, to the light receiver 24, to the motor 26, and to the encoder 28. Two-dimensional polar coordinates of all the objects in the monitored zone 18 are now available via the angle and the distance. All the named functional components are arranged in a housing 32 which has a front screen 34 in the region of the light exit and of the light entry.

In a technical safety application, the control and evaluation unit 30 preferably compares the position of the detected objects using one or more protected fields whose geometry is specified to or configured by the control and evaluation unit 30 by corresponding parameters. The control and evaluation unit 30 thus recognizes whether a protected field has been infringed, that is whether an unauthorized object is located therein and switches a safety output (OSSD, output signal switching device) in dependence on the result. An emergency stop of a connected machine monitored by the laser scanner 10 is thereby triggered or a vehicle on which the laser scanner 10 is installed is braked. Such a laser scanner is configured as a safety laser scanner by satisfying the standards named in the introduction or the comparable standards and by the measures required therefor.

It is conceivable to implement at least some of the control and evaluation unit 30 outside the laser scanner 10. However, at least the total safety related evaluation, including the distance measurement and the evaluation of the visual range explained below, is preferably part of the laser scanner 10 that can thus measure autonomously and can evaluate the safety.

The laser scanner 10 described with reference to FIG. 1 serves as an example of an optoelectronic sensor, but the invention is not restricted thereto. The most varied other constructions, in particular of laser scanners, are thus known, for instance with a biaxial instead of the coaxial arrangement of the light transmitter 12 and light receiver 24 here or with a rotating measuring head that comprises the laser transmitter 12 and/or the light receiver 24, or is coupled by light guides and having a plurality of measurement modules or additional movability to scan a three-dimensional spatial zone. Further alternatives are so-called solid state sensors in which, instead of the movable light deflection unit 16b, micromechanical systems such as micromirrors are used or designed scanning directions are achieved simply by an electronic control of, for example, an optical phased array or an acustooptical modulator.

The laser scanner 10 is also usable as a safety laser scanner under environmental conditions having restricted visibility and in particular in fog, that is, is outdoor enabled or is robust with respect to dirty surroundings. For this purpose, the laser scanner 10 is equipped with a function for the safe recognition of or warning of fog, that will be explained in more detail in the following. It is thus possible to react situatively to fog; the monitored machine can, for instance, be switched off or only braked or operated more slowly. This also applies to mobile applications, in particular for the case of a vehicle as the monitored machine.

FIG. 2 shows an exemplary received signal of a laser scanner in the region of a received pulse with a scanned object without fog or with good visibility. Strictly speaking, a plurality of received signals are superposed to have a feeling for the fluctuation range. This example has been recorded with an embodiment of the laser scanner 10 in which a filter has been inserted in the reception path, in particular a bandpass filter, in which an oscillation is triggered by the received pulse. An oscillation can therefore be seen instead of a simple peak. The reception time can be located at any desired characteristic of the oscillation, for example at its first zero crossing. A time offset of the selected characteristic within the extent of the oscillation can be compensated by calibration.

FIG. 3 shows an exemplary received signal in a situation comparable with FIG. 2, but now with dense fog with a meteorological visibility of only 30 m. The starting range is circled by a dashed line. A very distinguishable fog signature can be recognized in the first oscillations, in particular in the first three oscillations or also already only in the first oscillation. On the one hand, the amplitudes of the first positive and negative oscillations are very considerably reduced by the fog. This is inter alia due to the less steeply increasing flank of a received pulse that is reflected by fog, that transmits energy over a somewhat longer time, and that does not start the oscillation quite so fast, or due to interference effects. The oscillation furthermore now starts in the positive instead of the negative with a considerably varying amplitude. This sign change, even if it does not occur in every case despite the fog and even if a small negligible extreme in the negative can be present at the start of the oscillation as can be recognized in FIG. 3 when looking very closely, and the variation are likewise typical for fog and comparable visual influences such as dust. There are then more oscillations with a full deflection overall. All these differences or parts thereof are combined in a fog signature. A check is made with the fog signature, for example using combined thresholds, expected sequences, and characteristics of features, and the like, whether the situation of FIG. 2 is present in a received signal for a scanned object without fog or whether the situation of FIG. 3 with fog is present. Processes of machine learning, for example deep neural networks, can also be used for the check of a received signal with a fog signature. Further possible evaluation aids are folds, autocorrelations, or other correlations.

FIG. 4 is a representation of measurement points of a laser scanner 10. The angular resolution is very coarse due to the illustration; in reality, a measurement point is detected, for example, per degree or with an even finer angular resolution. The measurement points can be divided into semi hits 38 shown as dark and into direct hits 40 shown as light. A direct hit 40 designates a valid distance measurement of a scanned object. A distance value could also be measured with respect to semi hits 38. The check with the fog signature described in FIG. 3, however, came to the result that it is a measurement in fog. In addition to semi hits 38 and direct hits 40, there are still angles for which no distance value could be determined, either because neither object nor fog are present there or because no received pulse could be localized in time in the evaluation.

The check using the fog signature is still not sufficiently reliable for safe fog recognition at a high safety level. A semi hit 38 can, for example, also be caused by an edge hit. Further criteria are therefore preferably checked. These further criteria are presented in the following. All the further criteria are preferably satisfied together via the fog recognition using the fog signature. Such an AND operation is particularly robust with respect to false positive fog recognitions. However, embodiments having any desired subcombinations are also conceivable. A weighted combination is furthermore conceivable, with each criterion being treated as a fog feature and contributing to an evaluation sum with its individual weighting. If the evaluation sum is then above a fog threshold, this triggers the fog recognition overall.

A first further criterion expands the check to the presence of the fog signature in adjacent measurement points 38, 40, with such a neighborhood 42 being highlighted by way of example in FIG. 4. There must therefore be a minimum number of adjacent semi hits to satisfy this further criterion. Isolated semi hits are not sufficient for a robust fog recognition. A semi hit is preferably not immediately required for all the n angular positions in a neighborhood of n angular positions disposed next to one another, but rather only a number m<n. In the remaining n-m angular positions, the measured result for the first additional criterion is of no interest; direct hits 40, further semi hits 38, or, for example, also no measured results at all can be present there. It has been found to be particularly suitable to link a neighborhood n of at most twenty; in particular m=4 . . . 7 from n=8 . . . 12 is a favorable choice.

In addition to the criteria based on the fog signature, a plurality of additional criteria independent thereof are used, with independence here naturally meaning that the check is its own one, correlation can be given or is assumed since it is ultimately always a question of recognizing the presence of fog as a common feature. A first additional criterion relates to the absence of remote measured distance values. For background objects at greater distances that trigger a distance measurement are also detected again and again in operation without fog. An expectation of the frequency with which such greater distances should be measured as long as no fog is present can be derived therefrom. If this frequency, that can be quantified by a distance measurement number over a given time interval, for example, is no longer reached, this is an indication of fog.

A second additional criterion relates to the measured distance value that has to be within a predetermined fog distance region. The fog distance region extends, for example, from 0.5 m . . . 1 m to 5 . . . 10 m, preferably 0.5 m to 6 m. All the m semi hits 38 of the neighborhood 42 that are used for the neighborhood criterion m from n preferably have to have a distance in the fog distance region.

A third additional criterion is derived from a measure for the received energy of the received pulse; this is a level or an intensity of the received pulse. This largely corresponds to the integrated area of the received pulse. In the case of an oscillation as in FIGS. 2 and 3, the negative oscillation portions enter positively into the integral; the oscillation is so-to-say rectified before the integration. The intensity can be compared with the intensity expected of fog, with the expectation being able to be adapted to the measured distance value. The intensity expected from fog is related to its specific reflectivity. This can be quantified with reference to a minimal object or to a black test object in accordance with relevant safety standards such as IEC61496-3. Which intensity this minimal object generates from a respective distance is known. The expected intensity of fog can be set as a portion of the known intensity of a minimal object for the specification of the third additional criterion. An advantage range for this is located at 10% to 200% thereof, even more specifically in a somewhat narrower interval such as [20%, 80%], [30%, 80%], [20%, 50%] or [30%, 50%]. All the m semi hits 38 of the neighborhood 42 that are used for the neighborhood criterion m from n preferably have to have an intensity expected for fog.

A fourth additional criterion checks whether a reflector has possibly been scanned. This can be checked, for example, using a comparison of the intensity with a reflector threshold. The reflector threshold can be adapted to the measured distance. In a laser scanner 10, a reflector recognition can anyway be implemented for other purposes since the distance of a measurement point from a reflector can be corrected or requires special evaluations. The reflector recognition can be based on a measurement of the current of the light receiver 24. A measurement in its power supply such as described in EP 3 059 608 B1 described in the introduction is particularly advantageous.

If fog has been recognized using the said criteria, in particular an AND operation of the check with a fog signature, the m from n neighborhood conditions, and a plurality of or all the presented additional criteria, a time filtering with low pass properties can follow. A periodic scan can be called a scan with laser scanners 10; this approximately corresponds to a frame of a camera. The previously described fog recognition initially only relates to an individual scan. Fog is generally a sluggish weather phenomenon and occurs for a time period that is at least larger than a second, for example, while a laser scanner 10 typically works at a scan frequency of 50 Hz and more. It can therefore be sensible to require that the fog recognition is present over a plurality of consecutive scans. A certain tolerance is advantageous, for example fog recognition in 100 of 200 scans, similar to the neighborhood relationship of semi hits 38. No implausibly brief fog is thereby displayed. It is also ensured that fog nevertheless remains permanently recognized with a present fog that has already been recognized and with brief defects or misinterpretations of certain fog features. Conversely, a decay duration is conceivable that only cancels an earlier fog recognition when a plurality of consecutive scans, again preferably with a tolerance of, for example, 100 of 200 scans, no longer have the fog features. This then produces a kind of hysteresis overall.

The information that fog is present can initially simply be output as such as response to a fog recognition, for example by a status bit or a fog flag. It can be a piece of global information, but also appended to individual measurement points and can thus be resolved by angle or time. Fog can initiate the switchover to more robust protected fields or a corresponding dynamic adaptation of the protected fields. In addition, fog can result in a reduced speed of a monitored machine, in particular the speed of a vehicle or AGV (autonomous guided vehicle). A switching off with a standstill of the machine is no longer required so that the availability and thus the productivity are substantially increased. A further alternative comprises correcting the measured distances due to the influence of fog on the received signal since fog after all changes the characteristics of the received pulse, as can easily be recognized in FIG. 3. Safety related measures or adaptations then do not even have to be explicitly carried out due to the fog; the laser scanner 10 simply only measures more accurately in fog.

1. An optoelectronic sensor for the detection and distance determination of objects in a monitored zone, having a light transmitter for transmitting a transmitted pulse, a deflection unit for transmitting the transmitted pulse at different angular positions, a light receiver for generating a received signal, and a control and evaluation unit that is configured to recognize a received pulse in the received signal, that the transmitted pulse remitted or reflected in the monitored zone generates in the received signal and to measure a distance with reference to a time of flight between the transmission of the transmitted pulse and the reception of the received pulse, as well as to recognize the presence of fog by evaluating the received signal,
wherein the control and evaluation unit is configured to recognize the presence of fog by checking a time portion of the received signal with a fog signature corresponding to the received pulse, with the fog signature having a different time distribution, a different increase behavior, and/or a different amplitude of the received signal than in the case of a received signal from an object.

2. The sensor in accordance with claim 1,
wherein the control and evaluation unit is configured to recognize the presence of fog when the check with the fog signature produces this for a plurality of angular positions.

3. The sensor in accordance with claim 2,
wherein the control and evaluation unit is configured to recognize the presence of fog when the check with the fog signature produces this for at least m of n angular positions disposed next to one another.

4. The sensor in accordance with claim 1
that has a filter that is disposed downstream of the light receiver and that converts a received pulse into an oscillation, wherein the fog signature has a reduced amplitude of at least a first oscillation, a changed sign of at least the first oscillation, and/or a changed number of oscillations.

5. The sensor in accordance with claim 1,
wherein the control and evaluation unit is configured to transmit a plurality of individual light pulses per angular position that scan light pulses received again respectively with only a few thresholds and accumulate the scans into a digital received signal.

6. The sensor in accordance with claim 5,
wherein the control and evaluation unit is configured to transmit the plurality of individual light pulses per angular position that scan light pulses received again respectively with only a few thresholds binarize them with a single threshold, and accumulate the scans into a digital received signal.

7. The sensor in accordance with claim 1,
wherein the control and evaluation unit is configured to recognize the presence of fog only when at least one additional criterion is satisfied in addition to the check with the fog signature.

8. The sensor in accordance with claim 7,
wherein the at least one additional comprises that measured values outside a minimum distance disappear, that a measured distance is in a fog distance region, that the received signal has an intensity expected for fog, and/or that no reflector has been recognized.

9. The sensor in accordance with claim 7,
wherein the control and evaluation unit is configured for safe fog recognition in the sense of a safety standard for personal protection or electrosensitive protective equipment.

10. The sensor in accordance with claim 7,
wherein the control and evaluation unit is configured for safe fog recognition in the sense of a safety standard for personal protection or electrosensitive protective equipment by checking a plurality of or all all the additional criteria.

11. The sensor in accordance with claim 7,
wherein the control and evaluation unit is configured to check, as the additional criterion for the presence of fog, whether an expected distance measurement number of measured values outside the minimum distance has been detected.

12. The sensor in accordance with claim 7,
wherein the control and evaluation unit is configured to check, as the additional criterion for the presence of fog, whether an expected distance measurement number of measured values outside the minimum distance has been detected over a respective predetermined time interval.

13. the sensor in accordance with claim 7,
wherein the fog distance region comprises distances up to a maximum of 10 m.

14. The sensor in accordance with claim 7,
wherein the intensity corresponds to an intensity expected for fog, with the expected intensity being derived from the reflectivity of a black test object.

14. The sensor in accordance with claim 7,
wherein the intensity corresponds to an intensity expected for fog, with the expected intensity being derived from the reflectivity of a black test object being that intensity that an object having a reflectivity between 10% and 200% of the reflectivity of a black test object produces.

15. The sensor in accordance with claim 14,
wherein the control and evaluation unit is configured for a consistency check in which fewer or no distances outside a fog distance may be measured on the presence of an intensity expected for fog.

16. The sensor in accordance with claim 7
wherein the control and evaluation unit is configured to recognize a reflector by the fact that a current in the light receiver exceeds a reflector threshold.

17. The sensor in accordance with claim 7
wherein the control and evaluation unit is configured to recognize a reflector by the fact that a current in the light receiver exceeds a reflector threshold by measuring the current in a voltage supply of the light receiver.

18. The sensor in accordance with claim 1,
wherein the control and evaluation unit is configured only to recognize fog and/or no longer to recognize fog when it is confirmed over a plurality of measurements.

19. The sensor in accordance with claim 1,
wherein the sensor is configured as a safe sensor that has a safe output and whose control and evaluation unit is configured to output a safety related signal over the safe output on recognition of a safety related event in the monitored zone.

20. A sensor in accordance with claim 19,
wherein the control and evaluation unit is configured to recognize a safety related event by monitoring protected fields configured in the monitored zone and to apply stricter criteria for the presence of fog at angular positions and/or distances of a protected field.

21. A method of the detection and distance determination of objects in a monitored zone, wherein a light pulse is transmitted into one of a plurality of different angular positions and is received again to generate a received signal in which a received pulse is recognized that the light pulse remitted or reflected in the monitored zone generates, and a distance is measured between the transmission and reception of the light pulse with reference to a time of flight, and the presence of fog is recognized by evaluating the received signal,
wherein the presence of fog is recognized by checking a time portion of the received signal with a time signature corresponding to the received pulse, with the time signature having a different time distribution, a different increase behavior, and/or a different amplitude of the received signal than in the case of a received pulse from an object.
